(19) United States
(12) Patent Application Publication
(10) Pub. No.: US 2012/0284144 A1
(43) Pub. Date: Nov. 8, 2012

(54) System and Method for Evaluating Computerized Product Customization Tool and Associated Database(s)

(76) Inventors: Nathan Herbst, Middleton, WI (US); Peter Johnson, New Glarus, WI (US)

(21) Appl. No.: 13/365,765

(22) Filed: Feb. 3, 2012

Related U.S. Application Data
(60) Provisional application No. 61/439,617, filed on Feb. 4, 2011.
(60) Provisional application No. 61/471,922, filed on Apr. 5, 2011.
(60) Provisional application No. 61/506,894, filed on Jul. 12, 2011.

(51) Int. Cl. G06Q 30/00

(52) U.S. Cl. 705/26.5

(57) ABSTRACT

A computer-implemented method for assessing fidelity of a product customization tool for an electronic catalog including electronic records representing a plurality of customizable products, the customizable products including a plurality of configurable option selections is described. The method includes identifying a plurality of test case grouping including one or more customizable products having defined ranges of the configurable option selection that do not affect a key output parameter for the grouping and identifying a set of test cases selected from the test case groupings, the test cases having selections associated with the configurable option selection. The method further includes evaluating the set of test cases relative to identify instances of products in the electronic catalog conforming to the selections associated with the configurable option selection and generating a report providing differences between what was expected with the number of rules and actual results of the evaluating act.

### CROSS-REFERENCE TO RELATED APPLICATIONS

This application claims priority to U.S. Provisional Application No. 61/439,617, filed Feb. 4, 2011, U.S. Provisional Application No. 61/471,922, filed Apr. 5, 2011, and U.S. Provisional Application No. 61/506,894, filed Jul. 12, 2011, the entirety of each of which is herein incorporated by reference.

### FIELD OF THE INVENTION

The present invention is directed to a method and apparatus for evaluating a computerized and interactive product customization tool and validating the contents of a database containing consumer available manufacturing options for a customizable product available from a plurality of vendors.

### BACKGROUND OF THE INVENTION

Manufacturers of customizable products, such as replacement windows, offer a wide variety of options to satisfy the desires of consumers. By way of example, manufacturers of replacement windows offer various options to satisfy the myriad of consumer desired aesthetic choices, such as color, finish, number of panes, as well as, to comply with the physical requirements of the window opening. Manufacturers of other home remodeling products and appliances have a similar challenge. To help consumers in the product selection process, computerized programs have been developed that guide a customer service representative through a computerized catalog (database) based on consumer desired criteria in narrowing down to one or more product choices that best match the consumer desires. As the number of product choices increases and the number of manufacturers offering replacement product lines increases, parsing through the myriad of product choices even with the aid of a computerized interactive tool can be difficult. Moreover, if the parsing process is not well defined, it is possible for the interactive tool to “output” a replacement product that is not actually available for a manufacturer because it either includes a design option that is not available or outputs an incorrect price.

A number of efforts have been made to ensure the accuracy of a product customization or product ordering system. For instance, U.S. Publication No. 2003/0084379 discloses fact collection for a knowledge automation engine to use in detecting product issues on products. A knowledge automation engine may evaluate a check against a fact to detect a product issue on a product and provide a user of the product remediation information. A check may contain a product issue description, a rule to evaluate against a fact in order to detect the product issue, and remediation information to help a user address the product issue if the product issue is detected on the product. Product issues may include product installation validation and known product bugs. Facts used by the knowledge automation engine may include product configuration facts. Static facts may be collected into a fact repository. A fact collector may be used to collect facts not found in the fact repository but needed to execute checks on the knowledge automation engine.

U.S. Publication No. 2005/0102199 discloses a system and method that enables a user to configure a customizable product for purchase in an e-commerce system. A user may launch a web browser on a client computer system to access a vendor's web site to purchase a customizable product. The user may customize the product for purchase by selecting one or more customizable components of the product. A user may select one or more customizable components of the product by using a forms/menu interface or a visual graphical user interface. The vendor's web site may receive the one or more user selections for the customized product and may, in response, send data and information to client computer system to visually depict the “as purchased” customized product for user verification and product checkout.

U.S. Pat. No. 6,453,255 discloses a novel sales system of complex products whose configuration is designed based on customer requirements and provides a method for generating guarantee offers. A value of the guarantee criterion for the complex product (such as product availability) can be evaluated only after the complex product configuration is determined. For each combination of the customer requirements, a system configuration and a corresponding value of the guarantee criterion is generated. Then, this value is used for the customer remedy calculations.

U.S. Pat. No. 6,675,294 discloses a method and apparatus that enables interactively selection and configuration of a product among a set of related products based on availability and compatibility of features and options. It does not impose an order in the selection of products, features or options; only valid selections can be made at any time To create an electronic representation of the product information to achieve the above goal, the invention provides a framework for defining a system by defining the components of the system using elements contained in a parts catalog and defining relationships between the components of a system. A configuration system validates a configuration using the system definition, the current state of the configuration, and user input.

U.S. Pat. No. 7,069,357 discloses a constraint-based or rule-based model, in which nodes are interrelated by constraints, rules, and conditions, and addition of and changes to nodes are validated against relevant constraints. A mechanism is provided for performing such validation without loading the entire configuration, which includes a set of constraints and a set of node variables. In response to an intent to modify a node, a subset of the set of constraints is determined, which includes all constraints that restrict the intent to modify. Further, a subset of the set of node variables is determined, which includes all node variables that may have values that affect whether any of the subset of constraints is, violated. A subset of node variable information is loaded into volatile memory, which includes only information about the subset of node variables, rather than information about all of the nodes of the model.

U.S. Pat. No. 7,146 536 discloses a fact collection for a knowledge automation engine to use in detecting product issues on products. A knowledge automation engine may evaluate a check against a fact to detect a product issue on a product and provide a user of the product remediation information. A check may contain a product issue description, a rule to evaluate against a fact in order to detect the product issue, and remediation information to help a user address the product issue if the product issue is detected on the product. Product issues may include product installation validation and known product bugs. Facts used by the knowledge automation engine may include product configuration facts. Static facts may be collected into a fact repository. A fact collector may be used to collect facts not found in the fact repository but needed to execute checks on the knowledge automation engine.

U.S. Pat. No. 7,318,043 discloses a method, system, and computer-readable medium for assisting in automatically identifying and handling erroneous orders. In some situations, an automatic identification is made of received orders from users that are duplicates of one or more other orders recently placed by those users. When orders are identified as being potentially erroneous, fulfillment of those orders may be delayed while automatically querying the users to obtain manual confirmation to continue with the order fulfillment. In other situations, other types of orders are analyzed, orders are identified as being potentially erroneous in other ways, and such orders are handled in ways other than based on querying for a manual confirmation or rejection response.

Notwithstanding the advancements of these and other tools, processes, and systems, there remains a need for an improved process that is configured to test and thus validate the performance of a product customization tool for highly customizable products and the data used by such a tool. It is particularly desirable to have such a tool that is capable of back testing customized product.

### BRIEF SUMMARY OF THE INVENTION

The present invention provides a computerized system and process for testing software for product custom configuration including testing via specific rules and back tracking results for rule compliance. In one embodiment, the process includes validating a product selection tool and database to ensure that the output of the selection tool is a viable and commercially available option. Since there are at least dozens, if not more, options for many different replacement products, a computerized process is required to validate the contents of a replacement product database and test the accuracy of the product selection process. In this regard, the present invention provides an effective means of considering whether various permutations of a replacement product are viable commercial options.

One embodiment of the present invention relates to a computer-implemented method for assessing fidelity of a product customization tool for an electronic catalog including electronic records representing a plurality of customizable products, the customizable products including a plurality of configurable option selections is described. The method includes identifying a plurality of test case grouping including one or more customizable products having defined ranges of the configurable option selection that do not affect a key output parameter for the grouping and identifying a set of test cases selected from the test case groupings, the test cases having selections associated with the configurable option selection. The method further includes evaluating the set of test cases relative to identify instances of products in the electronic catalog conforming to the selections associated with the configurable option selection and generating a report providing differences between what was expected with the number of rules and actual results of the evaluating act.

Another embodiment of the present invention relates to a computer-implemented system for assessing fidelity of a product customization tool having a customization program embodied in computer executable code and a database containing data for of a plurality of design options for a customizable product. The system includes an electronic catalog database including electronic records representing a plurality of customizable products, the customizable products including a plurality of option selections, wherein at least one option selection is configurable. The system further includes a catalog testing program configured to identify a test case grouping including one or more customizable products wherein defined ranges of the configurable option do not affect a key output parameter for the grouping, identify a set of test cases representative of a plurality of test case groupings, the test cases having selections associated with the customizable options, and evaluate the set of test cases relative to identify instances of products in the electronic catalog conforming to the selections associated with the customizable options. The system further includes an error condition display configured to identify one or more differences between what was expected with the number of rules and actual results of the evaluating act.

One embodiment of the invention may be implemented wherein the customizable products are home building products and the option selections include a range of available sizes for the home building product. Evaluating the set of test cases relative to a number of rules can include identifying instances of customizable products in the electronic catalog conforming to the selections associated with the customizable options includes verifying a plurality of electronic data files associated with the instance of the customizable product.

The system can be configured to including a test case display providing a table of multiple test case groupings configured to receive a selection of a set of test cases representative of a plurality of test case groupings includes receiving a selection of table entries. The set of test cases may further be limited to one test case selection for inclusion in the set of test cases per row and column of the table.

Another embodiment of the present invention relates to a computer implemented method of evaluating the fidelity of a product customization tool having a customization program embodied in computer executable code and a database containing data for of a plurality of design options for a customizable product. The method includes generating a plurality of groupings of customizable products in an electronic catalog stored in a database, each grouping having a common key output parameter independent of selection of a design option for the customizable products in the grouping, defining one or more test products, each test product associated with a grouping of customizable products, executing the customization program to identify one or more customized products matched to the one or more test products for a subset of the plurality of groupings, and generating a log of errors from running the customization program.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a block diagram illustrating a system for product customization, in accordance with the present invention;

FIG. 2 is a data structure diagram representing an exemplary configuration for a customizable product database, in accordance with the present invention;

FIG. 3 is a block diagram illustrating an exemplary end product node for a specific configuration of a customizable product, in accordance with the present invention;

FIG. 4 is a block diagram illustrating a product customization application of FIG. 1, in accordance with the present invention;

FIG. 5 is a flowchart illustrating a product customization workflow configured to provide alternate quoting for one or more differently customized products, in accordance with the present invention;

FIG. 6 is a flowchart illustrating a workflow for generating and providing alternate quoting in the application of FIG. 5, in accordance with the present invention;

FIG. 7 is a flowchart illustrating the multiple openings workflow of Fig, 5 shown in greater detail, in accordance with the present invention;

FIG. 8, is a flowchart illustrating a workflow for providing product customization allowing the user to configure attributes for multiple lines in a product category, in accordance with the present invention;

FIG. 9 is a flowchart illustrating the standard size dimensioning workflow of FIG. 5 shown in greater detail, in accordance with the present invention;

FIG. 10 is a flowchart illustrating the single opening workflow of FIG. 5 shown in greater detail, in accordance with the present invention; and

FIG. 11 is a flowchart illustrating a workflow for validating the contents of a database containing consumer available manufacturing options for a customizable product available from a plurality of vendors, in, accordance with the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

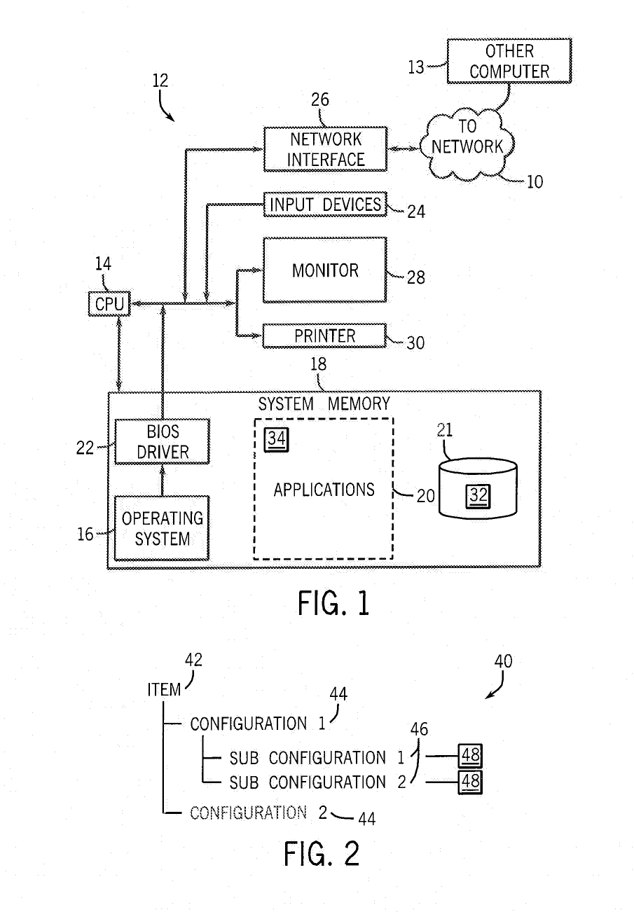

Referring first to FIG. 1, the components of a general purpose computing system 12 connected to a general purpose electronic network 10, such as a computer network, are shown, according to an exemplary embodiment. Computer system 12 may be configured to implement a system and method for customizing products including component parts. Computer system 12 may be located, for example within the design center of a home remodeling business, accessible through the Internet by a user on their home computing system, etc. Computer system 12 is configured to receive customization information for one or more products and accurately provide a listing, of one or more customized products that are satisfy criteria defined by the customization information.

The computer network 10 can be a virtual private network or a public network, such as the Internet. As shown in FIG. 1, the computer system 12 includes a central processing unit (CPU) 14 connected to a system memory 18. The system memory 18 typically contains an operating system 16, a BIOS driver 22, and application programs 20. In addition, the computer system 12 includes one or more input devices 24 such as a mouse or a keyboard, and output devices such as a printer 30 and a display monitor 28. System 12 further includes a permanent data store, such as a database 21. The computer system generally includes a network interface 26, such as an Ethernet card, to communicate to the electronic network 10. Other external computer systems 13 (one shown) connect to the electronic network 10 to exchange information with the system 12.

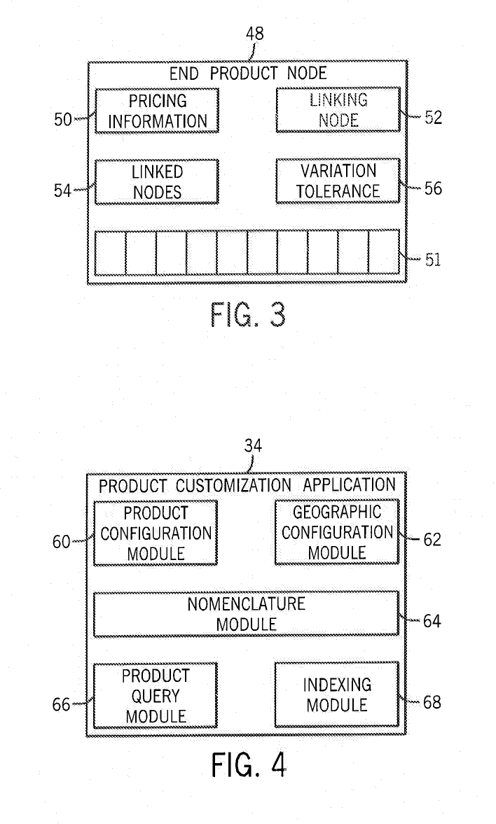

Database 21 may be configured to include a customizable product database 32 in an electronic catalog. An electronic catalog may be implemented as a database and the source code that guides a user through the customization process and interacts with the database containing the product information. Product database 32 may be configured to include a plurality of database items representative of commercial products and/or products that are components of one or more commercial products. Referring now to FIG. 2, a data structure diagram 40 representing an exemplary configuration for customizable product database 32 is shown. Diagram 40 illustrates one exemplary data structure that may be used for a customizable product 42 stored within the customizable product database 32.

A customizable product 42 may be associated with one or more product configurations 44. For example, a customizable product 42 may be a replacement window product. The replacement window product may be associated with a large number of configurable options, such as window type options (e.g., casement windows, double hung windows, etc.), window frame options (e.g., color, finish, type, etc), window glass options (e.g., number of panes, UV coating, glass thickness, etc.), hardware options, window sizing options to comply with the physical requirements of the window opening, etc. According to an exemplary embodiment, product configurations 44 may each be associated with a particular replacement window configuration option. Product configurations 44 may further be associated with product sub-configurations 46. For example, wherein a product configuration 44 are used to represent all of the various window type options for a particular window replacement product, product sub configurations 46 may be used to represent all of the various window glass options that are available for the particular product window type configuration 44. For example, it may be that only certain types of window glass may be used in casement windows, as indicated by the window glass product sub configurations 46 available for a window type product configuration 44. Although only one level of product sub-configurations 46 is shown, it should be easily understood how the data structure diagram 40 may be expanded to represent all possible implementations and configurations for a customizable product 42.

For each terminal configuration level of the diagram 40, comparable to a leaf node in a traditional data structure diagram, below which there are no further configurations 44 and/or sub-configuration 46, diagram 40 may include an end product node 48. End product node 48 may represent a specific representation of a customizable product 42 representing a specific selection of features for all of the customizable selections for the customizable product 42. For example, an end product node 42 may be used to represent a white, double pane casement window for a standard window opening. End product node 42 may be a database record including one or more associated information fields as described in further detail below.

A customizable product 42 may alternatively be defined based on association with one or more defined classes of products. Association with a defined class of products may include automatic incorporation of one or more features of that class. For example, a particular end product 48 may be defined as being a type of casement window. Accordingly, end product node 48 may be automatically populated with features of casement windows such as typical sizes, required installation hardware, available colors, etc. Each feature may be a separately customizable parameter for the end product.

Customizable product 42 may further be configured to be defined based one or more product definition rules based on the association with a defined class. For example, where the window is a casement window, product 42 may be defined to have a defined minimum size, may require selection of a particular type of window glass, etc.

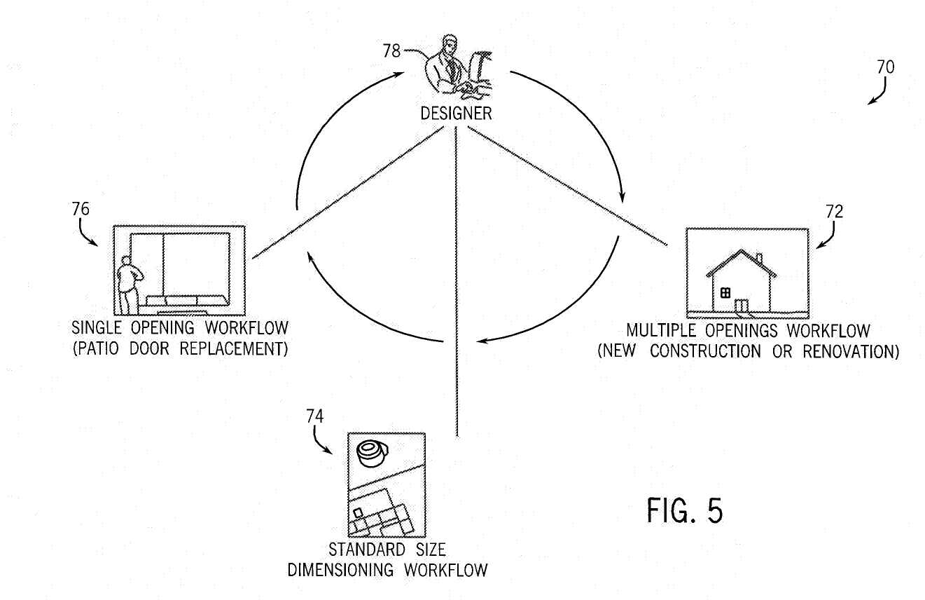

Referring now to FIG. 3, a block diagram illustrating an exemplary end product node 48 that may be configured to include additional information that can be generated for the specific configuration of the customizable product. Accordingly, end product node 48 may be configured to include pricing information 50, information fields 51, linking nodes 52, linked nodes 54, and a variation tolerance 56.

Pricing information 50 may represent a price of the customizable product 42. The pricing information 50 may be simple pricing information, in which the price is a numeric value provided during the creation of the node 48. Information fields 51 may be configured to include descriptive information such as text, pictures, video files, etc. Information fields 51 may be provides as links to files stored within database 32. The pricing information 50 may alternatively be complex pricing information in which the pricing is based on simple and/or complex pricing information from one or more other nodes 48. For example, for the white, double pane casement window for a standard window opening node 48, pricing information 50 may including pricing information for a window installation end node 48, a window hardware end node 48, a window glass end node 48, etc. Database 32 may be configured such that a change in the pricing information in an end node 48 is propagated to all of the nodes incorporating the pricing information from that node.

Linking nodes 52 may provide a listing of other end nodes incorporating the end node 48. The other end nodes may include complementary products, products that use the product represented by end node 48 in their customization, etc. Advantageously, database 32 may utilize the linking nodes 52 to recognize other nodes that would be affected by changes to the information associated with the end node 48. For example, if the end node 48 is configured to represent brass hardware for a double hung window, linking nodes 52 should include a listing of all windows that utilize the described brass hardware in their customization. Further, any change to the pricing for the brass hardware would need to be reflected in the pricing information of the end nodes 48 for those windows.

Linked nodes 54 may provide a listing of other end nodes incorporated by the end node 48. The other end nodes may include products that are used in the customization of the product represented by end node 48. For example, if the end node 48 is a window that uses brass hardware, linked nodes 54 would include the end node 48 described above.

Variation tolerance 56 may be used to identify and quantify one or more customizations for an end node 48 that may be varied without departing from the end node 48 (and requiring utilization of an alternative end node 48). For example, a customized replacement window product may be configured to define double hung windows having a defined set of customizations and a width between 24 and 27 inches wide. Advantageously, variation tolerance 56 may be used to reduce the number of required end nodes 48 within database 32 by incorporating a range of customizations that do not otherwise affect the data in the end node 48.

One of ordinary skill in the art would understand that FIG. 2, and the accompanying description, provides one implementation of a database 32, but that database 32 may be implemented using any number of methods and/or database systems. Yet further, database 32 may be configured to, link to one or more external systems, such as external system 13, and/or one or more external databases to provide the product customization functionality as described herein. Linking to an external data source may include uploading information from the external source for incorporation in the database 21 and/or providing links within the database to externally stored information, such as end nodes 48.

Referring again to FIG. 1, system 12 may be further configured to include a product customization application 34, stored within system memory 18 including steps performed by the CPU 14, for guiding consumer selection of a product from a multitude of choices and providing a cost estimate, e.g., price, for the consumer selection and also for presenting selected alternate product choices. Product customization application 34 will be described particularly with respect to guiding a consumer in the selection of replacement windows and doors, but it is understood that application 34 can be adopted for guiding consumer selection of other types of products.

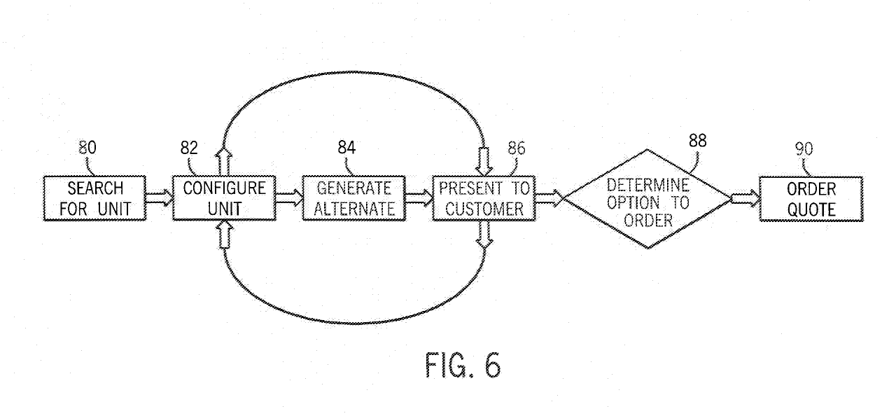

Referring now to FIG. 4, application 34 may be used in combination with the product information in database 21 to provide option-based, customizable products that allow a consumer to select among several design features. Application 34 provides a computerized interactive product selection guidance tool designed to assist customers (“users”) and designers in making informative cross-vendor selections of products. The interactive application 34 may also be used to assist end-users, e.g., retail customers, retailer representatives, and designers, in making informative selections between a myriad of products from a single vendor or manufacturer. The interactive application 34 is a comprehensive tool and thus includes a number of modules 60-68, or layers, built to guide a user through the product selection process.

The modules may include:

A product configuration module 60 including computer logic that identifies complimentary products and/or upgrade options, such that the user may be prompted to either purchase related complimentary products or an upgraded feature for the initial product. These complimentary products and/or upgrade option may be include as fields in an end node 48 associated with the selected product;

A geographic configuration module 62 incorporating geographic, i.e., regional or store specific, limitations in returning query results based on input data provided to the application 34. Exemplary limitations may include actual store inventories, suitability of product for the geographic location (e.g., single pane windows may not be suitable as replacement windows for northern climates), etc.;

A nomenclature module 64 that translates and/or converts manufacture specific marketing terminology into universal attributes which can be readily classified and searched. Module 64 may be configured to include a listing of terms used in database 21 and a listing of terms that may be considered as equivalents to those terms. Module 64 may be implemented by application 34 based on utilization of a number of different functions such as entry of search terms, incorporation of a new product into database 21, access of a database item on a remote system 13, etc. Application 34 and nomenclature module 64 allow system 12 to facilitate the search, or other function, for products for multiple manufacturers without learning manufacturer specific nomenclature;

A product query module 66 that enables retention of select product customization attributes while also enabling modification or alteration of other attributes between various queries. For example, module 66 may receive a product search query for double hung windows wherein the query has been customized to indicate that the user is only interested in products having a white trim. Where module 66 thereafter receives a query for complementary casement windows, module 66 can pre-populate the query to restrict the search to product having a white trim; and

An indexing module 68 that assigns and indexes performances attributes for a specific product or manufacturer, such that products can be queried in accordance with their respective performance attributes. Exemplary performance attributes may include, for example, insulation, light filtering and/or other properties of glass used in customizable windows such as r-values, condensation, u-values, etc.

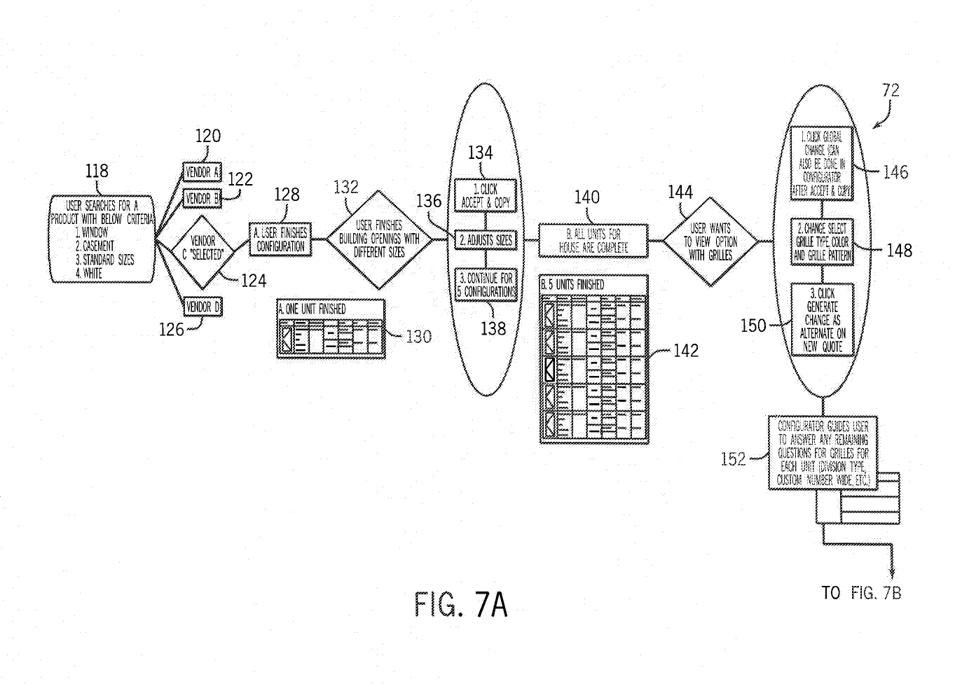

Referring now to FIG. 5, application 34 is configured to include a product customization workflow 70 configured to provide alternate quoting for one or more differently customized products. In the example shown in FIG. 5, application 34 may be used to define a workflow between a multiple openings window product customization 72, a standard size dimensioning window product customization 74, and a single opening window product customization 76.

Multiple openings window product customization 72 may be used to guide a customer or designer (hereinafter user) 78 through selection of multiple, repetitive instances of a product customization. In the example shown herein, customization 72 is used to select standard size, multiple opening, casement windows.

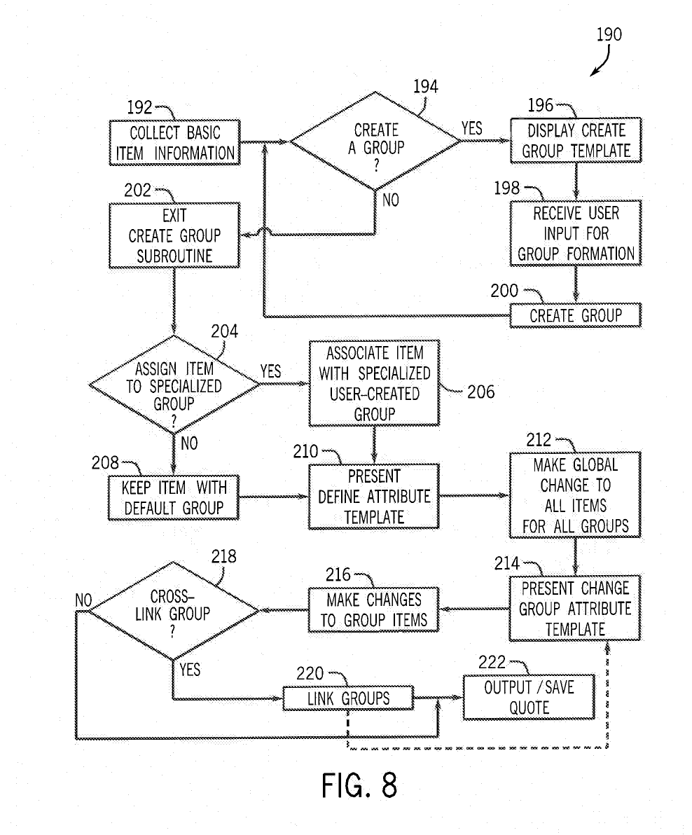

Customization 74 may be used to guide a customer through selection of a standard dimensioned window, such as a replacement window and customization 76 is used to guide a customer through selection of a product, such as a larger replacement window or a patio door for a single opening. Customizations 72-76 may be implemented by performing a number of steps, implemented as instruction in the application 34, as further described below with reference to FIGS. 7-10.

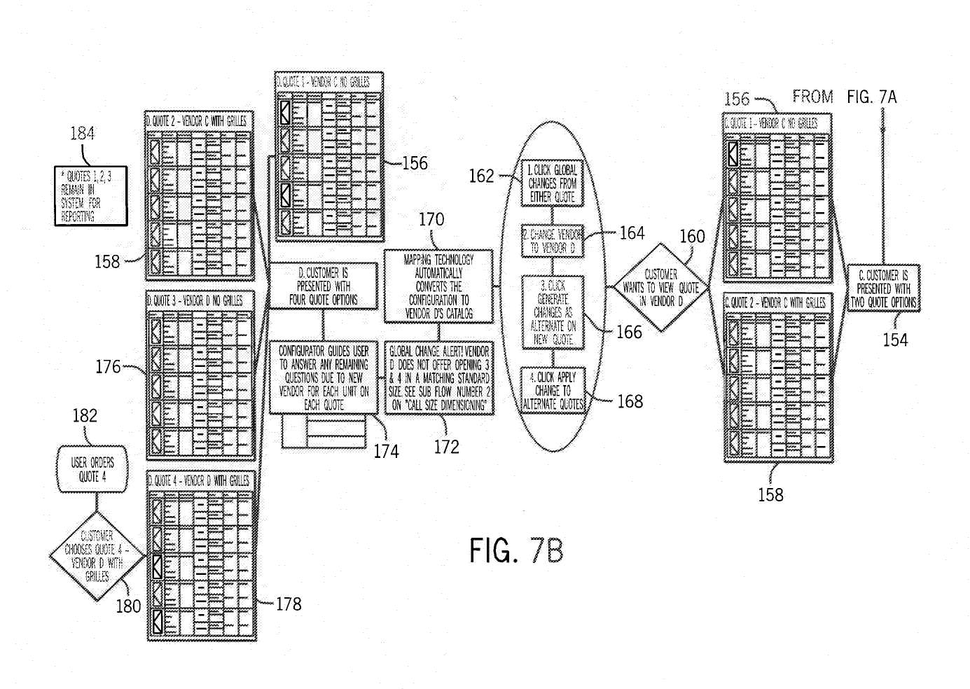

Referring now also to FIG. 6, application 34 may be generally configured to allows a user 78 to search for a product in a step 80, customize the product based on information provided by the user 78 in a step 82, generate an alternate unit configuration in a step 84, and present the original configuration and the alternate configurations to the user 78 in a step 86. The configuration, reconfiguration, and presentation to the user can be iteratively carried out until all product options from all available vendors are exhausted or the user selects an option to order in a step 88. The selected option can then be ordered in a step 90 according to the retailer purchase guidelines.

From the foregoing, it will be appreciated that the present invention has number of features that are believed to enhance the presentation of product customization to a customer and facilitate customer selection of products from multiple product sources, e.g., vendors. For example, application 34 may be configured to record and utilize product selection trends to facilitate alternate unit configuration is step 84. For example, application 34 may be configured to generate alternate unit configuration based on selections being made at other instance of application 34 in the same geographic area, when presenting the same product, when viewing the same vendor, etc.

Turning now to FIG. 7, the multiple openings workflow 72 is shown in greater detail. The workflow 72 may be a series of steps implemented by application 34 and begin with the user, which can be a customer or a retailer service agent, identifying one or more criterion for searching through a computerized product database (not shown) at block 118. In one embodiment, the search criterion includes a product type, e.g., window, a product subtype, e.g., casement, a product size, e.g., standard, and a product color, e.g., white. Application 34 may be configured such that the user 78 can select choices for the search criterion in a conventional manner and/or may provide free text search term entries.

Application 34 may be configured to correlate selection of inputs from the users with navigation of the product customization data structure 40. Each selection of search criterion by the user may be correlated to selection of a configuration 44 and/or sub-configuration 46 to identify one or more end product nodes 48 satisfying the provide search criteria.

Application 34 may further be configured to utilized nomenclature module 64 to correlate provided search terms to database items in database 21 and/or available through an external system 13. Application 34 may further be configured to modify a product description for an end product displayed to a user based on the nomenclature modifications identified by module 64. For example, where a user 78 enters solid core doors in the search criteria, and nomenclature module 64 identifies this term as correlating to a large grouping of different types of solid core doors in the products in database 21, the products descriptions may be configured to use solid core door to describe this product feature in the search results, in generated vendor quotes, in billing information, etc.

After receiving the user search inputs, the multiple openings workflow 72 then displays a listing of vendors 120, 122, 124, 126 that offer a product that meets the search criterion input by the user at block 118. The user can then interactively select, in a conventional manner, one of the vendors, such as vendor 124, as indicated in FIG. 7. The workflow 72 then enables the user to complete product configuration for the selected vendor at block 128. Completing product configuration in block 128 may correlate to selection of an end product node 48 from database 21. The workflow 72 then displays information for the built product (“unit”) at block 130. In one embodiment, the built or configured unit is presented with sufficient detail so that an invoice and/or work order (not shown) can be derived directly therefrom. Thus, for example, the description and price information retrieved from the end product node 48 for the available product(s) may be displayed.

The workflow 72 enables the user to finish (configure) windows for building openings having different sizes at block 132. In one embodiment, the workflow 72 copies the search criterion previously entered by the user at block 134, maps the data to the different sizes identified by the user at block 136, and then configures the additional units accordingly at block 138. In one embodiment, the workflow 72 generates up to four additional unit configurations. With all units now configured or finished at block 140, a quote 142 for the five total configurations is then displayed to the user.

The workflow 72 further allows a user to modify the finished units. Thus, based upon a selection of a product option to be modified at block 144, such as to view product options with grilles, the workflow 72 makes a global change for all search criterion at block 146, locates end nodes 48 corresponding to these changes, at block 148, and then generates an alternate quote at block 150. The workflow 72 then guides the user to answer any remaining questions regarding the user-desired option for each unit, such as division type, custom number wide, etc., at block 152.

From this information, the workflow 72 generates two separate quotes at block 154, which are presented as quote 156 and quote 158. A quote may be configured to include information from one or more end product nodes 48, such as product description information, product pricing information, etc. The two quotes are for the vendor previously selected by the user and show the finished units without the user-desired option input provided at block 144 and with the user-desired option.

Should the user still not be satisfied with the options available or desire to compare the selected vendor to the other vendors, the workflow 72 may receive user input including a request to view a quote from another vendor, e.g., vendor 126, at block 160. The workflow 72 then makes a global change at block 162 from either quote, changes to the data for the, new vendor at block 164, then generates an alternate quote at block 166. The user is then prompted to apply changes to the new alternate quotes, at block 168 if desired. If the user responds affirmatively, the workflow 72 automatically converts the configuration information input previously provided by the user at block 128 and block 136 to be consistent with the new vendor's product catalog data at block 170.

Application 34 may be configured to recognize when one or more design parameters, e.g., window size, input by the user may not be available from the new vendor, i.e., does not correlate to a valid end node 48, and prompts the user accordingly at block 172. Where application 34 successfully indentifies an alternative end node 48, the workflow 72 then guides the user through any vendor-specific inquiries regarding the available products at block 174. It is important to note that the user is prompted to answer vendor-specific queries for each unit on each quote. The user is then presented with four quotes—quotes 156, 158 which are for the originally selected vendor, and new quotes 176, 178 for the newly selected vendor, e.g., vendor 126.

From the displayed quotes, the user can then interactively making a selection by mouse clicking on a selected quote at block 180. The workflow 72 then places the order for the user selection at block 182. In a preferred embodiment, the non-selected quotes are stored in memory (not shown) and are used for statistical reporting at block 184, such as to provide feedback to one or more of the vendors. Additionally, while a sequential stepping through the workflow 72 has been described, it will be appreciated that the workflow 72 enables the user to return to a previous input or workflow block. For example, instead of choosing one of the four displayed quotes, the user could return to block 160 and instruct the workflow 72 to generate a quote for another one of the vendors.

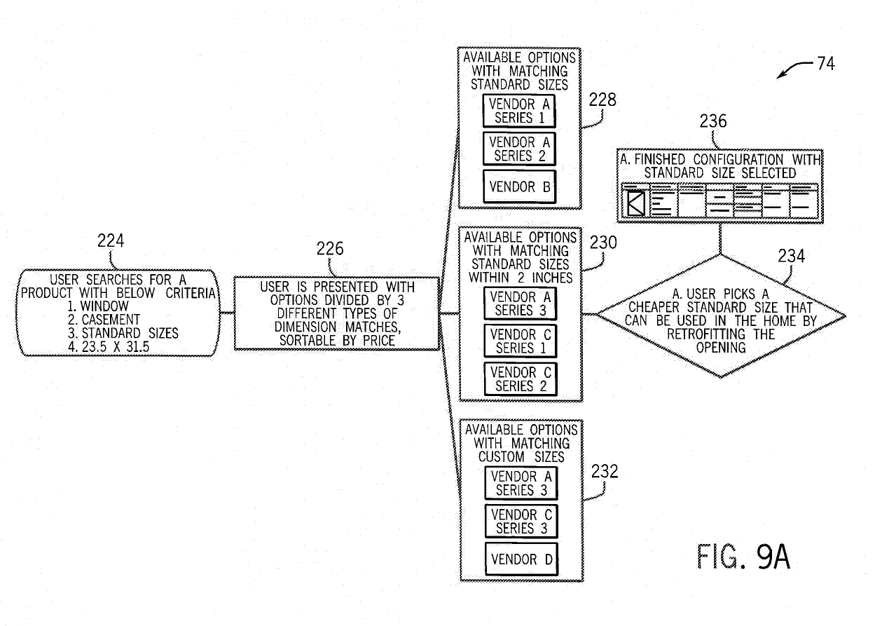

Referring now also to FIG. 8, workflow 72 describes one example of application 34 providing product customization in an application allowing the user to configure attributes for multiple lines in a product category simultaneously or generally at the same time, described above, for example, with reference to blocks 138 and 146-150 of FIG. 7. Application 34 may be configured to provide facilitated customization across a wide range of customizable products to provide significant time savings in replacement product configuration by allowing a user, such as a designer, to make simple, intelligent decisions about similarities between different line items while still preserving the unique attributes of each line item. This time savings is partly achieved by a system that enables the user to logically group line items based on a shared unique identifier and then let the user to make, global design modifications to each line item in the group. Thus, for example, application 34 avoids the need for the user to modify each line item individually.

As will be described in greater detail below, application 34 allows a user to configure attributes of multiple lines in a product category at the same time. In doing so, the user is able to build a product order with fewer user inputs. This logical grouping of product lines into one or more groups enables the user to make simple, intelligent decisions about the similarities between different line items (and potentially for multiple vendors), while still preserving the unique attributes of each line item. In order to implement this functionality, application 34 is configured to include a first workflow to create one or more groupings on item creation (on-the-fly) and a second workflow to create one or more groupings after item creation (post-configuration).

In the first workflow, while multiple items in a category are being virtually configured by a user, application 34 may be configured to generate a workflow product listing including some or all of the product information from one or more product end nodes 34, such that basic information is gathered and documented for all the items. The information may include, as an example, window size and a tracking identifier for the replacement window. The invention further allows the user to group the items in one or more user-defined (or predefined) virtual groupings as the items are being configured, described with further detail below. Referring again to a replacement window example, the user may identify the groupings based on physical location for the replacement window, i.e., north or south side of home. After the basic information has been collected for all the items, i.e., virtually configured products, specific attributes for all items in a group (or multiple groups) can then be globally changed or defined at the same time using application 34 rather than making attribute changes to each virtually configured product. Exemplary attributes that may be globally configured can include, but are not limited to, color, finish, grid layout, etc. Thus, if the user wishes to change from the default color for a virtual group of configured replacement windows to a new color, the user can change the color attribute for the virtual group(s) and the application 34 would automatically reconfigure each item in the virtual group. This global change thus reduces the number of inputs, and therefore the time needed, to configure a product for subsequent ordering, such as replacement windows or doors.

In the second workflow, application 34 allows a user to make changes to specific attributes of a line of products for a single vendor or across multiple vendors after the products have been fully configured. In this workflow, rather than grouping products as they are being configured, i.e., assigning each product item upon its creation, the items are virtually grouped by the user through application 34 after initial configuration. So, for example, an initial configuration could be with default design, characteristics and following user-defined grouping of the items, those default design characteristics could be changed on a per-group basis. While the above description describes a preferred embodiment in which a user controls the grouping, it is understood that application 34 may be configured to include control logic to automatically implement or to suggest to the user, predefined groupings to further assist and streamline the user experience and interaction.

FIG. 8 is a flowchart 190, depicting the first workflow implemented by the application 34, according to an exemplary embodiment. Although describing the first workflow, one of ordinary skill in the art would understand how one or more of the described steps may be performed in implementing the second workflow. In a block 192, the user provide inputs to the application 34 including information about the windows in the home, such as the size of the windows and the type of windows, e.g., double hung, casement, etc. During this collection of basic information, the user is prompted to create a group at block 194. A group may be defined as including one or more information fields in the database 21. The information fields included in a group may be fields within a single end product node 48 and/or information field from two or more end product nodes 48. It is understood that the user could be presented with predefined groups or could create a free form group by selecting information fields using application 34. Also, it is understood that the user could be prompted to create a group before the data collection process at block 192. For purposes of illustration and continuing the replacement window example, a user may use application 34 create a group called “FRONT OF HOUSE”,

To create a group, a CREATE GROUP template is displayed at block 196 to the user. Creation of a group may include creation of database record including a record identifier in database 21.

Thereafter, the application 34 creates a group as identified by the user at block 200. Application 34 may be configured to allow creation of multiple groups at a single time and therefore application 34 loops back to block 194 and prompts the user to create a new group. If the user desires a new group, blocks 196 and 200 are repeated; otherwise, application 34 exits the CREATE GROUP subroutine at block 202.

With the group created, application 34 prompts the user to associate an item, i.e., virtual replacement window, with the user-defined group at block 204, and if so, make the association at block 506 or keep the item associated with a default group at block 208. In block 204, the user can select one or more information fields and/or end product nodes for inclusion in the group. Block 204 may include receiving selection of items in a quote, such as described in block 146 with reference to FIG. 7, receiving a selection of one or more items displayed in search results, receiving a selection of one or more items displayed in an electronic catalog, etc.

More particularly, each item is automatically associated with a default group, as shown at block 208. That group may correspond to a home address, account number, or other unique identifier for the order or job. As such, by creating a new group, the user is identifying another virtual group separate from the virtual default group that the items could be associated with It is understood that the group could still be limited to a certain account number or address, or alternately, contain items from multiple addresses for example, which could occur for a homebuilder, developer, or rental property company.

After all the information for the replacement windows has been collected, the application 34 allows the user to define certain general attributes for all of the windows regardless of grouping. Application 34 presents a DEFINE ATTRIBUTE template to the user at block 210. The user can then provide, using a conventional I/O device, values for one or more attributes for the items of the groups—the default group and any user-created groups. Providing an attribute may include selection of one or more of the information fields in an end product node, selection of an attribute displayed in search results, etc. For example, the user can use the template of block 210 to define all of the replacement windows regardless of group—as vinyl, low-e, and standard hardware. Application 34 automatically defines the corresponding attribute for all virtual items for all groups at block 212.

Following resolution of global changes in block 212, application 34 is configured to display a CHANGE GROUP ATTRIBUTE template at block 214. The change attribute template allows the user to change or further define attributes of the items, but on a group-by-group basis. The tool then makes those design changes to the virtual items of the group at block 216. For example, assuming the user create a group titled “FRONT OF HOUSE” and populated that group with the replacement windows that are on the front of the house, the template would enable the user to make a color change, for example, to the replacement windows in that group without changing the default color setting, e.g., white, for all of the other windows. Such a color change may be desired, for instance, if the front of the house had a brick façade and the homeowner desired that the replacement windows on the front of the house have the same color as the brick façade.

As noted above, the CREATE GROUP subroutine can be called at any time during item configuration. So, for example, the user could, upon a customer desire to have all street side facing windows to have a certain grid pattern, access the CREATE GROUP template at block 196 and create an additional group called STREET FACING. The user could then access the list of identified windows and assign those windows that are street facing to the newly created group. The invention allows the user to assign a previously created group to a newly created group, i.e., crosslink groups. As such, assuming the house is a corner home having two street facing sides—the front of the house and the west side of the house—the user could then add the previous group “FRONT OF HOUSE” to the “STREET FACING” group so that any design attribute changes to this new group are automatically also made to replacement windows of the “FRONT OF HOUSE” group. Accordingly, when creating the new (second, third, etc.) group, application 34 is configured to prompt the user to determine whether to crosslink the new group with a preexisting group at block 218. If the crosslink is to be created, the link may be stored in a data field in database 21 including an instantiation of the end product nodes 48 included in the group.

It is understood that at any time after group creation, the user can use application 34 to access the CHANGE GROUP ATTRIBUTE template at block 214 to make modifications to the virtual items in one or more of the user-created groups. Similarly, the user could request that the DEFINE ATTRIBUTE TEMPLATE at block 210 to be displayed to allow the user to make group independent design changes to all of the virtual items. After all groups have been created and appropriately crosslinked, and all attribute changes have been made, the interactive tool can then output or otherwise save a quote (bid, contract, order, etc.) with the user-configured items at block 222.

According to another aspect, the invention allows a user to define characteristics of a subset of items in a quoted order in alternate ways. This allows the user to pick one configuration of each subset to compile together to generate the quote. It is believed that this provides a significant time savings and additional flexibility in generating quotes with several different feature and price options. In the most general terms, the invention allows users to create several options for a specific portion of an order. The combinations of that subset can be combined with combinations of other subsets to compile an entire order/quote. In this regard, several quotes can be quickly compiled with different sets of subset options.

This workflow can be triggered generally in one of three ways: (1) upon item creation; (2) upon cloning an option; and (3) upon option creation.

Regarding (1), when an item or subset of items is configured for the first time, an option is automatically created for that item or subset of items. This is a passive action. As such, the user can generate options without actively doing so Regarding (2), after an option has been created, the user has the ability to clone an existing option. Cloning an option copies it exactly and breaks the link to the original option. The user can then change the original or cloned option independently of one another to create an alternate, albeit potentially somewhat similar, option. That is, cloning the option saves time as all the previously defined configuration data for the original option is preserved and the user can just adjust one or more variables in the cloned option rather than re-defining all variables. Regarding (3), if the user wants to completely start a new configuration over from the beginning, which may be desirable/useful/required when configuring an item from a different catalog and/or vendor, the invention allows the user to create an entirely new option. This is different than (1) in that no preset variables are automatically established or previously configured data used from a previously created option.

It will be appreciated that all options may be configured to be independent from one-another. Application 34 can be configured such that changing one option has no effect on any existing options. Moreover, options include both configuration data and inclusion data. In this regard, one option setting is whether to include an item in the option. As such, one subset option may include all items while another option for that subset may include fewer than all of the items. This gives the user the opportunity to easily present the customer with a price for only some of the items under consideration.

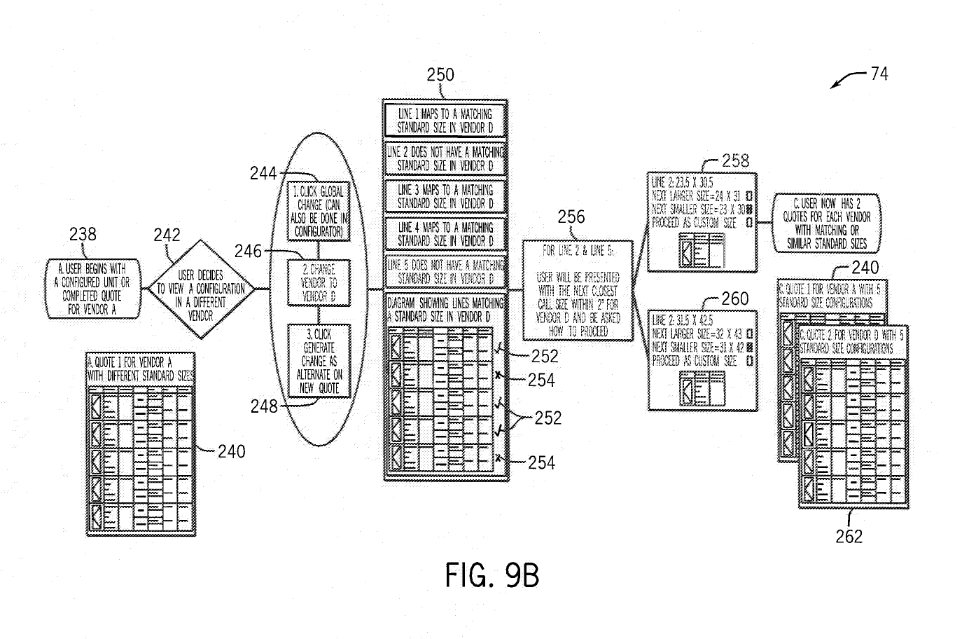

Referring now to FIG. 9, the steps of the standard size dimensioning workflow 74, first described above with reference to FIG. 5, are shown. As noted above, the standard size dimensioning workflow 74 is for those instances where the customer desires a standard sized window. Workflow 74 can be implemented in application 34 for guiding a customer, e.g., user, through selection of a standardized product that is available from multiple sources or vendors.

The workflow 74 begins with the user inputting various search criterion at a user interface to application 34 at block 224. The workflow 74 then presents the user with options segmented into various control groups, such as three different types of dimension matches, and sorts the options according to an identifier, e.g., purchase price, at block 226. The contents of the control groups, e.g., groups 228, 230, 232 are not vendor specific and thus may contain product options for various vendors.

Additionally, in a preferred embodiment, the control groups consist of options that exactly match the user-identified criteria, e.g., group 228, options that are selectively varied from the search criteria, e.g., group 230, and options that are not identical but substantially matched to the criteria, e.g., group 232. Thus, for example, group 228 provides a listing of available options from one or more vendors for a standard sized window. Group 230 provides a listing of available options from one or more vendors for the standard sized window within a dimension offset, e.g., within two inches. And, group 232 may contain a listing of available options from one or more vendors for a custom sized window.

The selective variants used to define groups 230 and 232 may be defined in a set of rules implemented by application 34 and stored with database 21. For example, each end product node 48 may be configured to include one or more variant factors associated with each information field 51. The variant factors may be configured such that selection of the variant will result in selection of an alternative end product node 48. Accordingly, the variant factors may be configured to be greater than the variant tolerance 56.

The workflow 74 then prompts the user to make a selection of one of groups 228-232 at block 234. In the illustrated example, the user is presumed to select an option from group 230 that requires slight resizing of the window opening. That is, the user selects an option for a window that is not matched to the user identified window opening, but can fit in the opening with modification to the window opening. A finished configuration and quote 236 is then presented to the user. Similar to the quotes described above, quote 236 includes a description of the product from the end product node 48 as well as the purchase price 50. Moreover, the displayed quote 236 can be used to complete a purchase/work order.

Workflow 74 further includes steps for the user to consider product options from a different vendor. More particular, the user begins with a configured unit or completed quote at block 238, such as quote 236. It is understood that the quote may be recalled from a saved quote 240 stored in memory of the computerized system or proceed to block 238 immediately after carrying out the acts associated with block 224 through block 236.

After the user inputs a desire to view a product configuration from a different vendor at block 242, the workflow 74 makes a global change to the previously entered configuration criteria so as to comply with the search parameters for the newly identified vendor at block 244 and then accesses the data, i.e., electronic catalog, for the new vendor at block 246. Accessing the data may include identification and utilization of one or more alternative end product nodes 48. The workflow 74 then prompts the user to generate change as an alternate product configuration at block 248.

Application 34 may further be configured to provide a mapping module, implemented by computing instructions, that maps the information of the previous quote to the data for the new vendor. For example, for each unit configuration of the previous quote, the mapping module determines if the new vendor offers a window size for the other user input criteria at block 250. Preferably, for each configuration that has a corresponding product option for the new vendor, a true marker 252, e.g., checkmark, is added to the corresponding lines in the previous quote. For each configuration that is not available from the new vendor, a false marker 254, e.g., “X”, is added to the corresponding lines of the previous quote. In a preferred embodiment, the workflow 74 presents the user with the next closest call size within a predefined dimension, e.g., two inches, for the configurations that do not have an exact match for the new vendor at block 256.

After prompting the user as to how to proceed at blocks 258, 260, the workflow 74 presents the user with the original quote 240 and a quote 262 for the new vendor. If approved by the user, the non-exact configurations are included in the quote 262 for the new vendor.

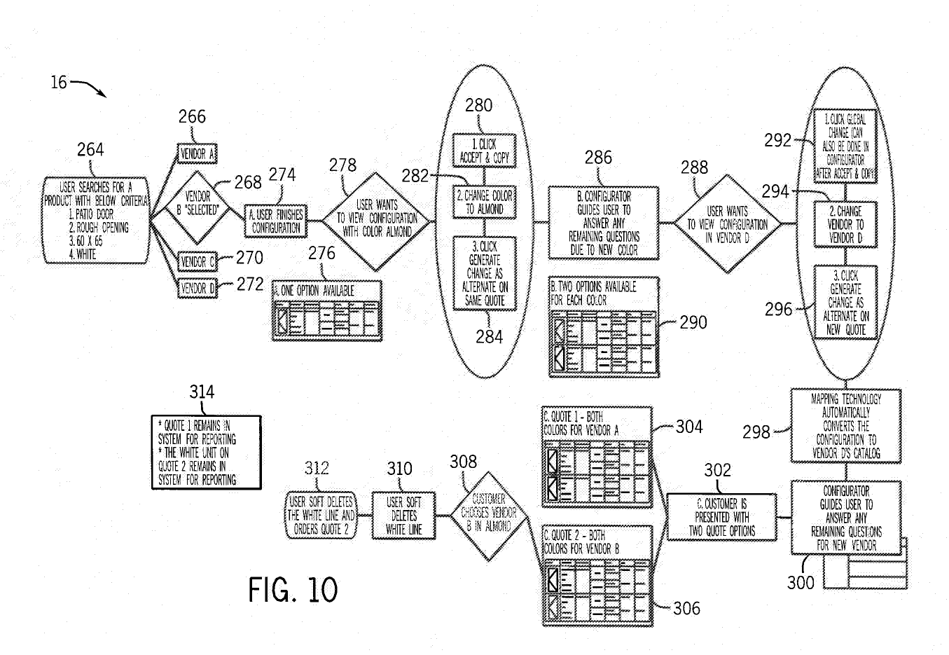

Turning now to FIG. 10, the steps of the single opening workflow 76 are shown. The workflow 76 begins with the user entering various search criterion at block 264. In one embodiment, the search criterion includes product type, e.g., patio door, opening size (“rough opening”), product dimensions, e.g., 60×65, and product color, e.g., white. The user can be prompted to select choices for the search criterion in a conventional manner.

After receiving the user search inputs, the single opening workflow 76 then displays a listing of vendors 266, 268, 270, 272 having a product that satisfies the search criteria input by the user. The user can than interactively select, in a conventional manner, one of the vendors, such as vendor 268. The workflow 76 then enables the user to complete product configuration for the selected vendor at block 274. Completing product configuration may include selection of one or more end customizable products 42. The workflow 76 then displays a listing of available options at block 276 that most closely match the search criteria and vendor-specific design choices input by the user, in one embodiment, the available options are presented with sufficient detail so that an invoice and/or work order (not shown) can be derived directly from selection of one or more end product nodes 48 from database 21. Thus, for example, the description and price information for the available product(s) are displayed.

The workflow 76 enables the user to make changes to previously entered selections at block 278. For example, the user may wish to view available options for the product in a different color, e.g., almond. Responsive thereto, the previous input search and configuration information are copied from the previous user inputs at block 280, the color input is changed to the new color option, e.g., almond, at block 282 and the user is prompted to generate the alternate quote at block 284.

The workflow 76 then prompts and guides the user to answer any remaining vendor-specific changes for the alternate product configuration at block 286. From the search criteria and additional configuration information, the workflow 76 displays a listing of the available options for both the original criterion choice, e.g., color white, and the new criterion choice, e.g., color almond, at block 290, The product options at block 290 are displayed in a manner similar to the original single product option at block 276.

The workflow 76 further enables a user to view product options for one of the other vendors, e.g., vendors 266, 270, or 272. In this regard, upon user input of an instruction to view configuration for one of the other vendors at block 288, the workflow 76 recognizes the user input as a global change for all previously entered criterion at block 292., changes the vendor to the user selected vendor at block 294, and then receives a user to generate an alternate product listing or quote at block 296.

The workflow 76 then automatically converts the configuration to the selected vendors catalog at block 298. That is, the workflow 76 matches the search criterion to the product listing for the selected vendor. The workflow 76 then guides the user to answer any vendor-specific inquiries for the input criteria for the new vendor at block 300. Using the search criteria and the user responses to the vendor-specific inquiries, the workflow 76 then generates two separate quote options at block 302. In one embodiment, these separate quote options are vendor specific and thus, in the illustrated embodiment, there is a quote 304 for vendor 268 and a quote 306 for vendor 272.

The quotes 304 and 306 are presented in a manner that allows the user to interactively select one of the products listed in each quote. So, for example, if the user mouseovers and selects option 2 for quote 306, in this example, the user would be selecting a product from vendor 272 with the color almond option at block 308. The user then soft deletes the white line at block 310 and then, if desires, orders the desired selection through suitable interactive input at block 312. The original quote, e.g., quote 304, and the non-selected option of the alternate quote, e.g., quote 306, is stored in memory (not shown) and can be used for statistical reporting at block 314.

From the foregoing, it will be appreciated that the present invention has number of features that are believed to enhance the presentation of product customization to a customer and facilitate customer selection of products from multiple product sources, e.g., vendors, From the foregoing, it will be appreciated that aspects of the present invention may have applications beyond that explicitly described above. For example, in addition to mapping between product offerings, i.e., catalogs, of multiple vendors, the nomenclature module may also be used with a single vendor having product offerings that fall into numerous product categories. The present invention therefore allows a single manufacturer to segment their product offerings into multiple product categories and then users in the manufacturer's sales channels can then consider the products for the several product categories in a much more efficient and streamlined manner. For instance, a single manufacturer may segment their product offerings into categories based on quality of craftsmanship and materials, i.e., “silver”, “gold”, and “platinum”. As a consumer desired product may be found in each of these product categories from the single manufacturer, the present invention allows for user, e.g., sales representatives, to efficiently identify and quote products (and alternate products) for each of the categories. It will therefore be appreciated that the present invention can be scaled for use by a single manufacturer or by a retailer offering similar products from several vendors or manufacturers.

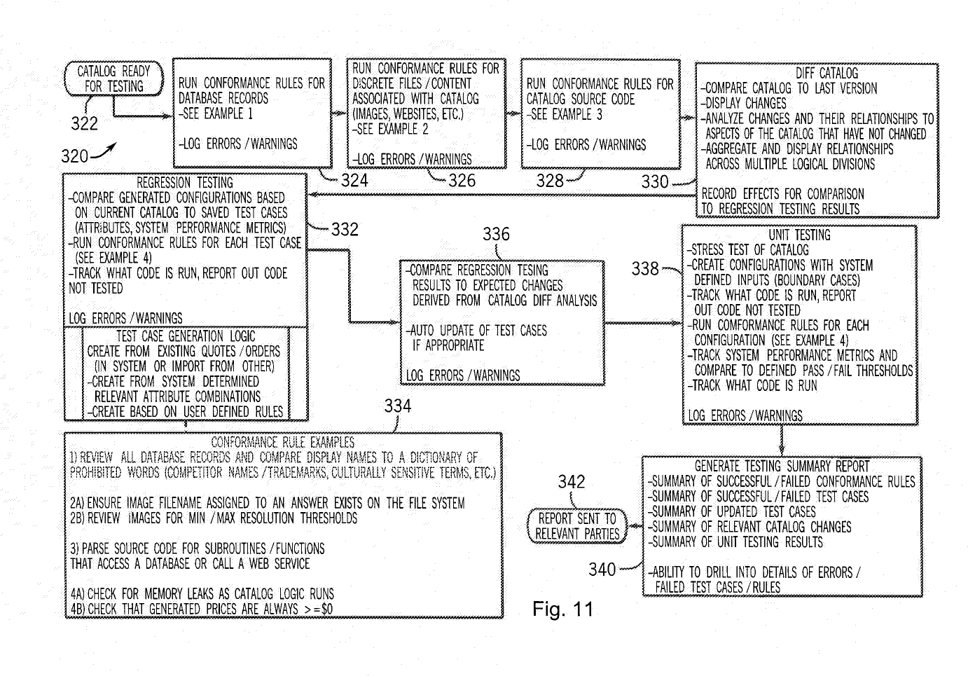

Referring now to FIG. 11, application 34 may be configured to implement a workflow 320 for evaluating the alternative quoting workflows described above with reference to FIGS. 5-10 and validating the contents of database 21 containing consumer available manufacturing options for a customizable product 42 available from a plurality of vendors. Workflow 320 may be executed by application 34 to implement a product customization testing process begins with accessing a product database (“catalog”) to be evaluated at block 322. A catalog may be implemented as a database and the source code that guides a user through the customization process and interacts with the database containing the product information. Initially, the contents of the database are evaluated relative to various conformance rules at blocks 324, 326, and 328. These evaluations can be carried out simultaneously or sequentially and may differ from the order shown in the figure.

Generally, conformance rules evaluations may be performed to evaluate data stored in database 21 or to be incorporated into database 21 in view of specific defined conditions. For instance, the data is evaluated to determine if an end product node 48 includes prohibited text and/or images that may be displayed to a user during the product customization process described above. The data may be evaluated through user input, text parsing and matching, etc. Exemplary prohibited data may include competitor names/tradernarks, culturally sensitive terms, proprietary pricing or cost information, etc. It will thus be appreciated that these conformance tests are run for the database records at block 324, for discrete files or content associated with the catalog (images, websites, etc.) at block 326, and for catalog source code at block 328. In addition to fettering out prohibited items, this part of the process 320 is used to ensure that a file referenced by the product customization tool actually exists either in the database or a server containing the source code for the product customization program. Errors or potential errors are flagged and preferably logged in a log maintained by the application 34.

Evaluating the source code, for example in block 328, can includes parsing the catalog source code to insure that the source code does not include any undesirable or poor coding practices. For example, the code may be parsed to ensure that all “loops” have exit conditions, that custom code is not being used to access the database, and that no web service calls to the Internet are embedded in the code.

After the conformance testing has been done in blocks 324328, the catalog under evaluation is compared to a previous version of the catalog at block 330. The difference between the two versions can be logged for analysis and/or displayed on a user interface (not shown) to allow a user to visually consider the differences between the catalog versions to ensure the intended changes between catalogs have been made and, if not, can be made. In addition, the process evaluates the data that is different between the two versions and then determines whether other aspects of the data, while the same as the earlier version, may result in a different output because of differences in the data.

For example, a new catalog may incorporate a five percent increase for hardware. The new catalog may further specify that hardware pricing is controlled via five rules that reference ten look up, tables within the database including the new catalog. The rule logic in the new catalog may be the same but some of the values in the look up tables will have now changed based on the new pricing. According, this difference would be displayed in block 330 to show that the tables have been affected in the determined ten tables. Workflow 320 further searches all rules and locates the rules that reference the look up tables that have the identified change. Workflow 320 then looks for all products, represented by end product nodes 48 that apply the affected rules. The user may then be presented with several different views, of this affected data in block 330. For instance, a list of the pricing rules can be displayed in which each rule has a visual link to an associated changed look up table(s). Alternately, or additionally, each affected product type can be displayed along with a visual link to an affected rule(s). Thus, in the above example, workflow 320 provides an aggregation of the product and pricing rule information. It is contemplated that other rule types could be aggregated.

Following application of the conformance rules against the catalog, process 320 may be configured to test specific configurations that can be created with the catalog. These configurations include “known” configurations as well as intelligently randomized testing. For purposes of describing the process, the testing of a “known” configuration is referred to as “regression testing” and testing of a randomized configuration is referred to as “unit testing”,

Unit testing may include identifying grouping of similar products. Similar products may be grouped together based on recognition that variation with the configurable options associated products in that grouping will not affect a key output parameter. For example, a grouping may be built based on recognition that vendors can customize door sizes within a particular range within affecting pricing. Accordingly, all door products within the particular range can be grouped together since variations will not affect the outcome of the conformance rules.

Product groupings may be presented in a tabular form to allow a user to easily identify product groupings and select test cases from the product groupings. The test cases may be selected electronically based on a selection algorithm, such as by selecting one test case from each product grouping, selecting one test case per row and column of product groupings, selecting a defined percentage of test cases from product groupings, etc.

In a preferred implementation of the present invention, regression testing is carried out before unit testing but the invention is not so limited. Thus, workflow 320 continues to block 332 and carries out the steps of regression testing. Regression testing generally involves testing the catalog and the associated data against known test cases. Parameters such as price, attributes, unit drawing, and the like are compared. That is, test cases are created and evaluated. So, in the example of a replacement window, several test “replacement windows” are customized and evaluated to determine if the output is a commercially available replacement product.

Test cases can be created in a number of ways. For example, existing customer quotes and/or orders can be used Alternately, test cases can be built automatically by identifying situations where pricing/attributing filtering will occur based on the catalog data An example of this would be to review pricing rules, and see that the price modifier depends on the unit's height in ranges. Thus, a “test” case could be selected for each range. Test cases could also be created from user defined rules. For example, the user could create a test case for a vinyl double hung window, exterior color green, and Lo-e2 coated glass. A “test” case is then created in which every standard height and width combination would be tested for the aforementioned user-defined parameters.

During the regression testing steps of workflow 320, conformance rules will also be applied to the catalog and data at block 334. More specifically, arbitrary rules may be run against specific configurations. These conformance rules include some rules which allow the code to be evaluated to ensure that any custom code did not overwrite what was checked at the database conformance rule level. Other rules inherently check aspects of the catalog that cannot be determined at the database level. For example, a memory leak rule may be provided to identify memory leaks in the code.

Additionally, system performance metrics are captured as the catalog logic is running, i.e., source code is being executed. This data is compared and tracked over time to evaluate performance of the code. Thresholds and other flags may be used to issue warnings and/or identify errors. This information is used to help product experts, as well as programmers, in setting up the catalog so that differences between versions are seamless, i.e., new versions do not execute substantially slower than old versions.

Next workflow 320 creates a log, or displays a listing, containing the differences between expected regression test results and actual regression test results at block 336. This information allows the user to see what discrepancies, if any, there are between what was expected and what actually occurred. Additionally, workflow 320 allows the user to update all or a subset of test cases based on the results of the regression test. For example, if the new catalog includes a five percent increase in hardware price, the catalog difference analysis performed at block 336 provides a listing of a rules, look up tables, products, etc. that were affected by the price increase. The test cases showed an average 5.1 percent increase in the hardware price modification. The user can then update the test cases to use the newly generated price so that during actual use of the customization tool, products exact to the test cases have a correct hardware price.

Also during the regression test portion of workflow 320, the source code can be tracked to determine which code portions of the code are actually being run. This can be used to identify unused portions of the code and determine why the code was not used during the process. The developers can then use this information to further streamline the code to provide a more efficient customization tool.

Workflow 320 then executes a series of steps for unit testing at block 338. Unit testing of the catalog amounts to stress testing of the catalog. In unit testing, unexpected inputs are made to evaluate how the code handles the unexpected input. For example, a free text field is input with a code rather than free field text. Stress testing the code is designed to find where and under what conditions the code fails. In short, unit testing is designed to test the limits of the code and the database contents for evaluating how robust the customization tool is.

In addition to stress testing, unit testing also includes running conformance rules, gather performance metrics, and evaluate code coverage similar to that carried out during regression testing.

After testing is complete, the process generates a summary of test results at block 340. The summary includes a log or listing of the successful/failed conformance rules, successful/failed test cases, summary of updated cases, summary of relevant catalog changes, and summary of unit testing results. It is contemplated to evaluate approximately 2000-4000 test cases and provide those results in the summary report. However, it can be appreciated that the number of test cases may be varied without deviating from the scope of the present invention. Also, the summary report preferably includes a listing of the inputs that were used during unit testing.

The summary report is then electronically transmitted to relevant parties, such as testing teams, code developers, vendors, etc., at block 342.

Embodiments of the present invention are described above with reference to the accompanying drawings. It should be understood that the following description is intended to describe exemplary embodiments of the invention, and not to limit the invention. In a general aspect, the present invention provides a system, a computer implemented method, and a computer readable medium storing software that provides customization services (e.g., home product catalog item customization) for complex goods.

Embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

In addition to a system, the invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention, in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the words “component” or “module” as used herein and in the claims is intended to encompass implementations using one or more lines of software code, and/or hardware implementations, and/or equipment for receiving manual inputs.

What is claimed is:

1. A computer-implemented method for assessing fidelity of a product customization tool for an electronic catalog including electronic records representing a plurality of customizable products, the customizable products including a plurality of configurable option selections, comprising:
(a) identifying a plurality of test case grouping including one or more customizable products having defined ranges of the configurable option selection that do not affect a key output parameter for the grouping;
(b) identifying a set of test cases selected from the test case groupings, the test cases having selections associated with the configurable option selection;
(c) evaluating the set of test cases relative to identify instances of products in the electronic catalog conforming to the selections associated with the configurable option selection;
and
(d) generating a report providing differences between what was expected with the number of rules and actual results of the evaluating act.

2. The method of claim 1, wherein the customizable products are home building products and the option selections include a range of available sizes for the home building product.

3. The method of claim 1, further including displaying the test case grouping includes displaying a table of multiple test case groupings, and identifying a set of test cases representative of a plurality of test case groupings includes receiving a selection of table entries.

4. The method of claim 3, wherein the set of test cases is limited to one test case selection for inclusion in the set of test cases per row and column of the table.

5. The method of claim 1, wherein evaluating the set of test cases relative to a number of rules includes identifying instances of customizable products in the electronic catalog conforming to the selections associated with the customizable options includes verifying a plurality of electronic data files associated with the instance of the customizable product.

6. The method of claim 1, wherein evaluating the set of test cases relative to a number of rules includes comparing pricing information based on the selection of the configurable information to pricing information for instances of products in the electronic catalog.

7. The method of claim 1, wherein the customizable products further include a plurality of rules associated with the option selections, wherein the rules include instructions for modifying at least a second customizable option based on a selection associated with a first customizable option.

8. The method of claim 1, wherein the key output parameter is a price.

9. A computer-implemented system for assessing fidelity of a product customization tool having a customization program embodied in computer executable code and a database containing data for of a plurality of design options for a customizable product, comprising:
(a) an electronic catalog database including electronic records representing a plurality of customizable products, the customizable products including a plurality of option selections, wherein at least one option selection is configurable;
(b) a catalog testing program configured to
identify a test case grouping including one or more customizable products wherein defined ranges of the configurable option do not affect a key output parameter for the grouping;
identify a set of test cases representative of a plurality of test case groupings, the test cases having selections associated with the customizable options;
evaluating the set of test cases relative to identify instances of products in the electronic catalog conforming to the selections associated with the customizable options; and
(c) an error condition display configured to identify one or more differences between what was expected with the number of rules and actual results of the evaluating act.

10. The system of claim 9, wherein the customizable products are home building products and the option selections include a range of available sizes for the home building product.

11. The system of claim 9, further including a test case display providing a table of multiple test case groupings configured to receive a selection of a set of test cases representative of a plurality of test case groupings includes receiving a selection of table entries.

12. The system of claim 3, wherein the set of test cases is limited to one test case selection for inclusion in the set of test cases per row and column of the table.

13. The system of claim 9, wherein evaluating the set of test cases relative to a number of rules includes identifying instances of customizable products in the electronic catalog conforming to the selections associated with the customizable options includes verifying a plurality of electronic data files associated with the instance of the customizable product.

14. The system of claim 9, wherein evaluating the set of test cases relative to a number of rules includes comparing pricing information based on the selection of the configurable information to pricing information for instances of products in the electronic catalog.

15. The system of claim 9, wherein the customizable products further include a plurality of rules associated with the option selections, wherein the rules include instructions for modifying at least a second customizable option based on a selection associated with a first customizable option.

16. The system of claim 1, wherein the key output parameter is a price.

17. A computer implemented method of evaluating the fidelity of a product customization tool having a customization program embodied in computer executable code and a database containing data for of a plurality of design options for a customizable product, the method comprising:
generating a plurality of groupings of customizable products in an electronic catalog stored in a database, each grouping having a common key output parameter independent of selection of a design option for the customizable products in the grouping;
defining one or more test products, each test product associated with a grouping of customizable products:
executing the customization program to identify one or more customized products matched to the one or more test products for a subset of the plurality of groupings; and
generating a log of errors from running the customization program.

18. The method of claim 17, wherein identifying one or more customized products matched to the one or more test products includes verifying a plurality of electronic data files associated with the one or more customized products.

19. The method of claim 17, further including comparing pricing information for the one or more customized products to the pricing information generated for the one or more test products.

20. The method of claim 17, further including executing a plurality of rules associated with each test product and determining, based on the execution of the rules, whether the test products can be matched to at least one customizable products in the electronic catalog.
